(19) United States
(12) Patent Application Publication
(10) Pub. No.: US 2013/0260954 A1
(43) Pub. Date: Oct. 3, 2013

(54) TOROIDAL CONTINUOUSLY VARIABLE TRANSMISSION MECHANISM

(71) Applicant: HONDA MOTOR CO., LTD, Tokyo (JP)

(72) Inventors: Kentaro Arai, Wako-shi (JP); Kazuma Hatakeyama, Wako-shi (JP); Takao Sato, Wako-shi (JP); Nobuhiro Kira, Wako-shi (JP); Takashi Matsumoto, Wako-shi (JP)

(73) Assignee: HONDA MOTOR CO., LTD, Tokyo (JP)

(21) Appl. No.: 13/827,920

(22) Filed: Mar. 14, 2013

(30) Foreign Application Priority Data
Mar. 27, 2012 (JP) 2012-070678

(51) Int. Cl. F16H 15/38

(52) U.S. Cl. CPC F16H 15/38
USPC 476/40

(57) ABSTRACT

A toroidal continuously variable transmission mechanism includes: a biasing device for biasing an input disc in a direction in which the input disc becomes closer to an output disc to press the input disc and the output disc against power rollers; a first bearing for supporting an input shaft on the input disc side; a second bearing for supporting the output disc; a first support member whose one end side is fixed to a base member, and which supports the first bearing; a second support member whose one end side is fixed to the base member, and which supports the second bearing; and a connecting member which connects opposite end sides of the first and second support members. Reaction forces are transmitted to the input disc and the output disc from the power rollers, and are supported by internal stresses of the base member and the connecting member.

### CROSS-REFERENCE TO RELATED APPLICATION

The present application claims priority under 35 U.S.C. §119 to Japanese Patent Application No. 2012-070678, filed Mar. 27, 2012, the contents of which is incorporated herein, by reference, in its entirety.

### TECHNICAL FIELD

The present invention relates to a toroidal continuously variable transmission mechanism comprising: an input disc supported by an input shaft in a way that is incapable of rotating relative to the input shaft and capable of sliding over the input shaft in an axial direction; an output disc supported by the input shaft in a way that is capable of rotating relative to the input shaft and capable of sliding over the input shaft in the axial direction; a pair of power rollers held between the input disc and the output disc; biasing means for biasing the input disc in a direction in which the input disc becomes closer to the output disc along the input shaft to press the input disc and the output disc against the pair of power rollers; a base member; and a pair of trunnions for supporting the pair of power rollers in a way that is capable of tilting and turning, and supported by the base member in a way that is capable of sliding in a direction of trunnion axes.

### BACKGROUND OF THE INVENTION

Japanese Patent Application Laid-open No. 10-47448 has made publicly known a toroidal continuously variable transmission mechanism in which: power rollers 5 are held between an input disc 2, supported at a left side of an input shaft 6 in a way that is incapable of rotating relative to the input shaft 6 and capable of sliding in an axial direction, and an output disc 3, supported at a right side of the input shaft 6 in a way that is capable of rotating relative to the input shaft 6 and capable of siding in the axial direction; the input disc 2 is rightward biased towards the output disc 3 by biasing means (cam roller) 12 provided in a left end of the input shaft 6; a right end of the input shaft 6 is supported by a right side surface of a casing 1 with an input bearing 13 interposed in between; a right end of the output disc 3 is supported by a left side surface of the casing 1 with an output bearing 14 interposed in between.

In the above-mentioned conventional toroidal continuously variable transmission mechanism, when the power rollers 5 are held between the input disc 2 and the output disc 3 by rightwardly biasing the input disc 2 toward the output disc 3 by the biasing means 12 provided in the left end of the input shaft 6, leftward reaction force which the input disc 2 receives from the power rollers 5 biases the input shaft 6 leftward, and is thus transmitted to the casing 1 from the input bearing 13 provided in the right end of the input shaft 6. In addition, rightward reaction force which the output disc 3 receives from the power rollers 5 is transmitted to the casing 1 from the output bearing 14 provided in the right end of the output disc 3.

For this reason, the input shaft 6 receives not only a torsional load due to the torque transmission, but also a tensile load in the axial direction due to the reaction force which the input disc 2 receives from the power rollers 5. As a result, the diameter of the input shaft 6 needs to be increased in order for the input shaft 6 to withstand both the torsional load and the tensile load. This poses a problem of an increase in the weight and dimensions of the toroidal continuously variable transmission mechanism.

### SUMMARY OF THE INVENTION

The disclosure has been made with the foregoing situation taken into consideration. The present disclosure is to prevent tensile load in an axial direction from working on an input shaft of a toroidal continuously variable transmission mechanism.

According to a first feature of the disclosure, there is provided a toroidal continuously variable transmission mechanism comprising: an input disc supported by an input shaft in a way that is incapable of rotating relative to the input shaft and capable of sliding over the input shaft in an axial direction; an output disc supported by the input shaft in a way that is capable of rotating relative to the input shaft and capable of sliding over the input shaft in the axial direction; a pair of power rollers held between the input disc and the output disc; a biasing device for biasing the input disc in a direction in which the input disc becomes closer to the output disc along the input shaft to press the input disc and the output disc against the pair of power rollers; a base member; a pair of trunnions for supporting the pair of power rollers in a way that is capable of tilting and turning, and supported by the base member in a way that is capable of sliding in a direction of trunnion axes; a first bearing for supporting the input shaft on the input disc side; a second bearing for supporting the output disc; a first support member whose one end side is fixed to the base member, and which supports the first bearing; a second support member whose one end side is fixed to the base member, and which supports the second bearing; and a connecting member which connects opposite end sides of the first and second support members.

With the configuration of the first feature, when the power rollers are pressed against the output disc by biasing the input disc by the biasing device in a way that the power rollers do not slip over the input disc or the output disc, the input disc and the output disc are biased in directions in which the input disc and the output disc become farther away from each other due to reaction forces which the input disc and the output disc receive from the power rollers. The reaction force which the output disc receives from the power rollers is transmitted as tensile load in one direction from the second bearing to the base member and the connecting member via the second support member, while the reaction force which the input disc receives from the power rollers is transmitted as tensile load in the opposite direction from the biasing device to the base member and the connecting member via the input shaft, the first bearing and the first support member. For this reason, these two tensile loads balance internal stresses of the base member and the connecting member. Accordingly, the tensile loads are prevented from being applied to the input shaft. As a result, only torsional load due to torque transmission works on the input shaft. This makes it possible to decrease the diameter of the input shaft, and thus to reduce the size and weight of the toroidal continuously variable transmission mechanism.

According to a second feature, in addition to the first feature, bolts for connecting the opposite end sides of the first and second support members to the connecting member are placed in a direction of an axis of the input shaft.

With the configuration of the second feature, the bolts for connecting the opposite end sides of the first and second support members to the connecting members are placed in the direction of the axis of the input shaft. For this reason, when the loads of the input disc and the output disc receiving the reaction force from the power rollers are transmitted from the first support member and the second support member to the connecting member via the bolts, the loads are transmitted in the direction of the axes of the bolts. This makes it possible to decrease the diameters of the bolts, and makes it less likely that the bolts loosen.

According to a third feature, in addition to the second feature, a shim is held between the second bearing and the output shaft, and an end surface of the connecting member with which the opposite end side of the second support member is in contact, and a side surface of the output disc with which the shim is in contact, are orthogonal to the axis of the input shaft.

With the configuration of the third feature, the shim is held between the second bearing and the output disc; and the end surface of the connecting member with which the opposite end side of the second support member is in contact and the side surface of the output disc with which the shim is in contact are orthogonal to the axis of the input shaft. For this reason, when the positions of the end surface of the connecting member and the side surface of the output disc in the axial direction are measured for the purpose of selecting the thickness of the shim, the measuring work is easy to carry out.

Here, a first thrust bearing 26A of an embodiment corresponds to the first bearing; a second thrust bearing 26B of the embodiment corresponds to the second bearing; and a stepped portion b of an output disc 15 of the embodiment corresponds to the side surface of the output disc.

The above and other objects, characteristics and advantages will be clear from detailed descriptions of the preferred embodiment which will be provided below while referring to the attached drawings.

### BRIEF DESCRIPTION OF THE DRAWINGS

The advantages of the invention will become apparent in the following description taken in conjunction with the drawings, wherein:

FIG. 1 is a schematic diagram of a transmission comprising a toroidal continuously variable transmission mechanism;

FIG. 2 is a perspective view of the toroidal continuously variable transmission mechanism;

FIG. 3 is a sectional view taken along a line 3-3 in FIG. 2;

FIG. 4 is a sectional view taken along a line 4-4 in FIG. 3; and

FIG. 5 is a sectional view taken along a line 5-5 in FIG. 3.

### DETAILED DESCRIPTION OF THE INVENTION

An embodiment of the disclosure will be described below based on FIGS. Ito 5.

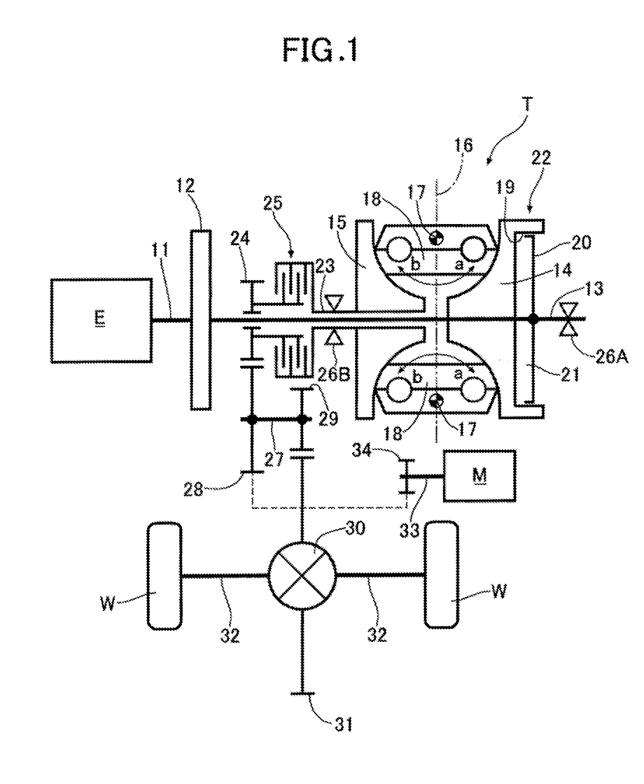

As shown in FIG. 1, a single-cavity toroidal continuously variable transmission mechanism T provided in a transmission for a vehicle includes an input shaft 13 connected to a crankshaft 11 of an engine E with a damper 12 in between. An input disc 14, formed of a substantially-cone-shape, is supported by the input shaft 13 in a way that is incapable of rotating relative to the input shaft 13 and capable of sliding over the input shaft 13 in an axial direction. An output disc 15, formed of a substantially-cone-shape, is supported by the input shaft 13 in a way that is capable of rotating relative to the input shaft 13 and capable of sliding over the input shaft 13 in the axial direction. A pair of power rollers 18 supported in a way that is capable of rotating about a roller axis 16 and capable of tilting and turning about trunnion axes 17 are in contact with the input disc 14 and the output disc 15. Opposed surfaces of the input disc 14 and the output disc 15 have a toroidal curve surface. Once the power rollers 18 tilt and turn about the respective trunnion axes 17, points of the contact of the power rollers 18 with the input disc 14 and the output disc 15 change.

Biasing means 22 is formed from: a cylinder 19 integrally formed on an outer periphery of the input disc 14; a piston 20 fixed to an outer periphery of the input shaft 13, and slidably fitted in an inner peripheral surface of the cylinder 19; and an oil chamber 21 defined between the cylinder 19 and a piston 20. For this reason, when the input disc 14 is biased toward the output disc 15 by supplying hydraulic oil pressure to the oil chamber 21, the power rollers 18 can be pressed against the input disc 14 and the output disc 15 without slippage.

An output shaft 23 integrally connected to the output disc 15 is fitted to the outer periphery of the input shaft 13 in a way that is capable of rotating relative to the input shaft 13. A first gear 24 supported by the outer periphery of the input shaft 13 in a way that is capable of rotating relative to the input shaft 13 can be linked to the output shaft 23 via a clutch 25. A shaft end of the input shaft 13 is supported by means of a first thrust bearing 26A made from an angular ball bearing; the output disc 15 is supported by means of a second thrust bearing 26B made from an angular ball bearing; a second gear 28 fixedly provided to an intermediate shaft 27 is in mesh with the first gear 24; a final drive gear 29 fixedly provided to the intermediate shaft 27 is in mesh with a final driven gear 31 provided to a case of a differential gear 30. Driving wheels W are connected to drive shafts 32 extending leftward and rightward from the differential gear 30.

A third gear 34 provided to an output shaft 33 of an electric motor M is in mesh with the second gear 28.

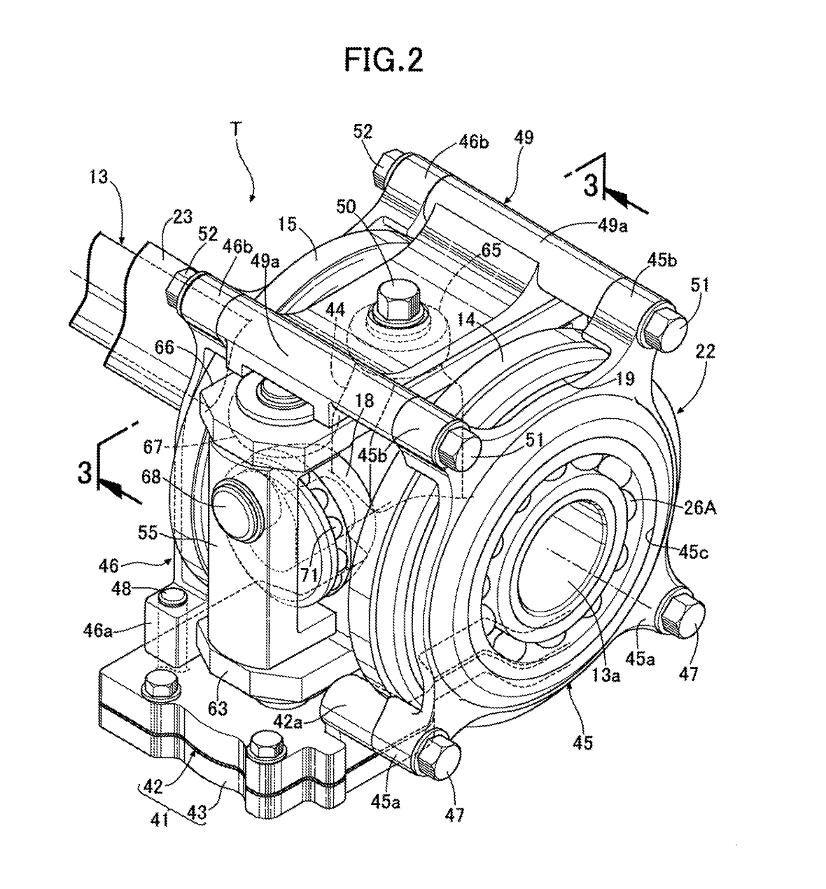

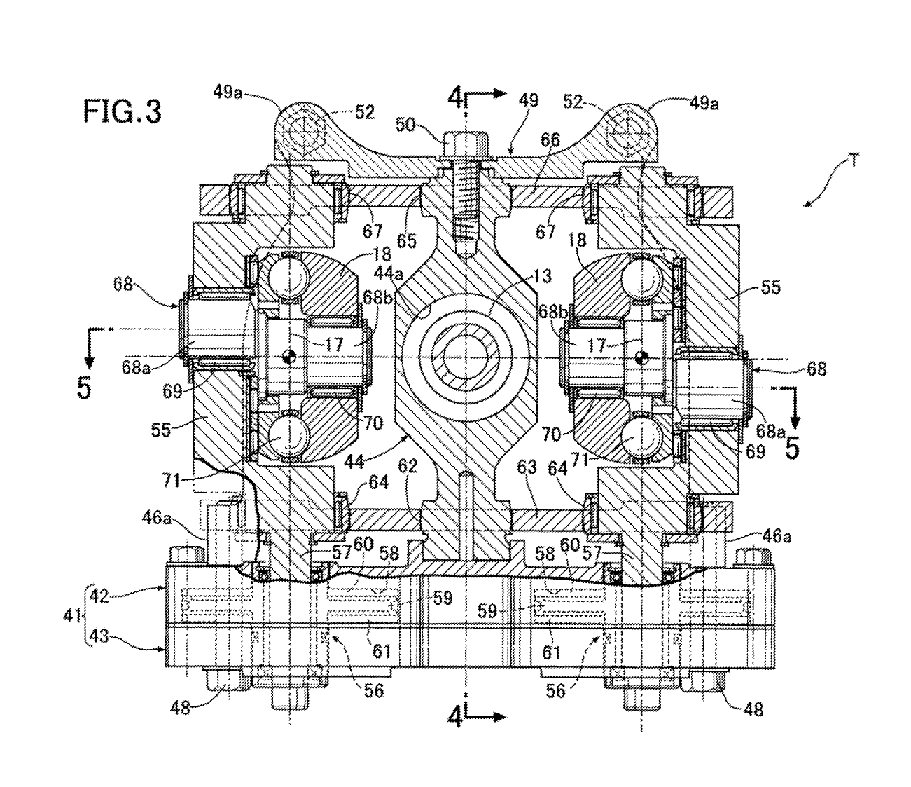

Next, more specific descriptions will be provided for the structure of the toroidal continuously variable transmission mechanism by referring to FIG. 2 to FIG. 5.

The toroidal continuously variable transmission mechanism T includes an upper valve plate 42 and a lower valve plate 43 which are overlapped each other in an up-down direction for the purpose of forming a base member 41. A lower end of a link post 44 is fixed to a center portion of the upper valve plate 42 by press-fit. In addition, lower ends of a first support member 45 and a second support member 46 are fixed so as to interpose the link post 44. To put it specifically, a pair of lower fixing portions 45a are formed in the lower end of the first support member 45; and the first support member 45 is fixed to the upper valve plate 42 by screwing bolts 47, which penetrate the lower fixing portions 45a in a horizontal direction, to fixing portions 42a projectingly provided to the upper valve plate 42. In addition, a pair of lower fixing portions 46a are formed in the lower end of the second support member 46; and the second support member 46 is fixed to the upper valve plate 42 by screwing bolts 48, which penetrate the base member 41 from above to below, to the lower fixing portions 46a.

A plate-shaped connecting member 49 is horizontally placed above the base member 41. The connecting member 49 is fixed to the link post 44 by screwing a bolt 50, which penetrates a center portion of the connecting member 49 from above to below, to an upper end of the link post 44. Furthermore, the connecting member 49 includes a pair of tubular fixing portions 49a. A pair of upper fixing portions 45b provided to the first support member 45 and a pair of upper fixing portions 46b provided to the second support member 46 are fixed to the opposite ends of the pair of fixing portions 49a of the connecting member 49 by use of bolts 51 and bolts 52. Accordingly, a solid box-shaped frame is formed from the base member 41, the first support member 45, the second support member 46, the link post 44 and the connecting member 49.

Circular openings 45c, 46c are formed in center portions of the first support member 45 and the second support member 46, respectively. The input shaft 13 is placed in a way that penetrates the openings 45c, 46c. A large-diameter portion 13a, on one end side, of the input shaft 13 is rotatably supported by the opening 45c of the first support member 45 by means of the first thrust bearing 26A. The piston 20, formed of a disc-shape, is press-fitted to the outer periphery of the input shaft 13 in a way that comes in contact with the large-diameter portion 13a. The cylinder 19 integrally formed on an outer periphery of the input disc 14 supported by the input shaft 13 by means of a ball spline 53 in a way that is incapable of rotating relative to the input shaft 13 and capable of sliding over the input shaft 13 in the axial direction is slidably fitted to an outer periphery of the piston 20.

On the other hand, the output disc 15 is supported by the outer periphery of the input shaft 13 by means of a needle bearing 54 in a way that is capable of rotating relative to the input shaft 13 and capable of sliding over the input shaft 13 in the axial direction. A tubular shaft portion 15a of the output disc 15 is rotatably supported by the opening 46c of the second support member 46 by means of the second thrust bearing 26B. In addition, the tubular output shaft 23 is fitted to the outer peripheral of the input shaft 13 protruding outwards from the second support member 46 in a way that is capable of rotating relative to the input shaft 13, and is spline-connected to the shaft portion 15a of the output disc 15. A shim 72 with a predetermined thickness is interposed between an inner race of the second thrust bearing 26B and a stepped portion of the output disc 15. The space between the input disc 14 and the output disc 15 is adjusted by the shim 72.

An intermediate portion of the input shaft 13 between the input disc 14 and the output disc 15 penetrates an opening 44a formed in a center portion of the link post 44.

A pair of trunnions 55 for supporting the pair of power rollers 18 are placed with the input shaft 13 interposed in between. Piston rods 57 of left and right hydraulic actuators 56 provided to the base member 41 are integrally formed on lower ends of the trunnions 55, respectively. Each hydraulic actuator 56 includes: a cylinder 58 formed between the upper valve plate 42 and the lower valve plate 43 of the base member 41; a piston 59 slidably fitted in the cylinder 58, and fitted to an outer periphery of the piston rod 57 in a way that is capable of rotating relative to the piston rod 57; an upper oil chamber 60 defined on an upper side of the piston 59; and a lower oil chamber 61 defined on a lower side of the piston 59.

A center portion of a lower link plate 63 is pivotally supported by a lower portion of the link post 44 by means of a spherical joint 62. Opposite end portions of the lower link plate 63 are pivotally supported by lower portions of the pair of trunnions 55 by means of spherical joints 64, respectively. Furthermore, a center portion of an upper link plate 66 is pivotally supported by an upper portion of the link post 44 by means of a spherical joint 65. Opposite end portions of the upper link plate 66 are pivotally supported by upper portions of the pair of trunnions 55 by means of spherical joints 67, respectively.

Each of pivot shafts respectively 68 for supporting the trunnions 55 in the power rollers 18 includes: a trunnion support portion 68a rotatably supported by the trunnion 55 by means of a needle bearing 69; and a power roller support portion 68b for rotatably supporting the power roller 18 by means of a needle bearing 70. In one of the pivot shafts 68, the trunnion support portion 68a is downward offset from the power roller support portion 68b. In the other of the pivot shafts 68, the trunnion support portion 68a is upward offset from the power roller support portion 68b. Moreover, a ball bearing 71 is placed between each power roller 18 and the corresponding trunnion 55 for the purpose of allowing the power roller 18 to smoothly move relative to the trunnion 55.

The operation of the toroidal continuously variable transmission mechanism will be described below.

Once the lower oil chamber 61 becomes higher in pressure than the upper oil chamber 60 in one hydraulic actuator 56 out of the pair of hydraulic actuators 56, the upper oil chamber 60 becomes higher in pressure than the lower oil chamber 61 in the other hydraulic actuator 56. For this reason, the pair of piston rods 57 are driven in opposite directions to each other. With regard to the pair of trunnions 55, one trunnion 55 moves upward along its trunnion axis 17, while the other trunnion 55 moves downward along its trunnion axis 17. During this process, the upward and downward movements of the left and right trunnions 55 can be synchronized together by the operations of the lower link plate 63 and the upper link plate 66. When the pair of trunnions 55 move in opposite direction to each other, the power rollers 18 together with the trunnions 55 tilt and turn about the respective trunnion axes 17 in directions indicated with arrows a, b due to reaction force received from the input disc 14 and output disc 15.

For example, when the power rollers 18 tilt and turn in the direction indicated with the arrow a, the points of the contact of the power rollers 18 with the input disc 14 move outwards in the radial direction from the input shaft 13, while the points of the contact of the power rollers 18 with the output disc 15 moves inwards in the radial direction toward the input shaft 13. For this reason, the rotation of the input disc 14 is transmitted to the output disc 15 through acceleration, and the ratio of the toroidal continuously variable transmission mechanism T continuously changes to an OD side. In contrast, when the power rollers 18 tilt and turn in the direction indicated with the arrow b, the points of the contact of the power rollers 18 with the input disc 14 move inwards in the radial direction toward the input shaft 13, while the points of the contact of the power rollers 18 with the output disc 15 move outwards in the radial direction from the input shaft 13. For this reason, the rotation of the input disc 14 is transmitted to the output disc 15 through deceleration, and the ratio of the toroidal continuously variable transmission mechanism T continuously changes to a LOW side. Subsequently, the rotation of the output disc 15 is transmitted to the driving wheels W in route of the output shaft 23→the clutch 25→the first gear 24→the second gear 28→the intermediate shaft 27→the final drive gear 29→the final driven gear 31→the differential gear 30→the drive shafts 32.

It should be noted that: when the electric motor M is driven for forward rotation, the vehicle can be made to run forward by use of the output from the electric motor M, or the driving force of the engine E can be assisted by the output from the electric motor M; and when the electric motor M is driven for reverse rotation, the vehicle can be made to run backward. In addition, if the electric motor M is made to function as a generator by use of driving force reversely transmitted from the driving wheels W while the vehicle is decelerated, kinetic energy of the vehicle body can be recovered as electric energy.

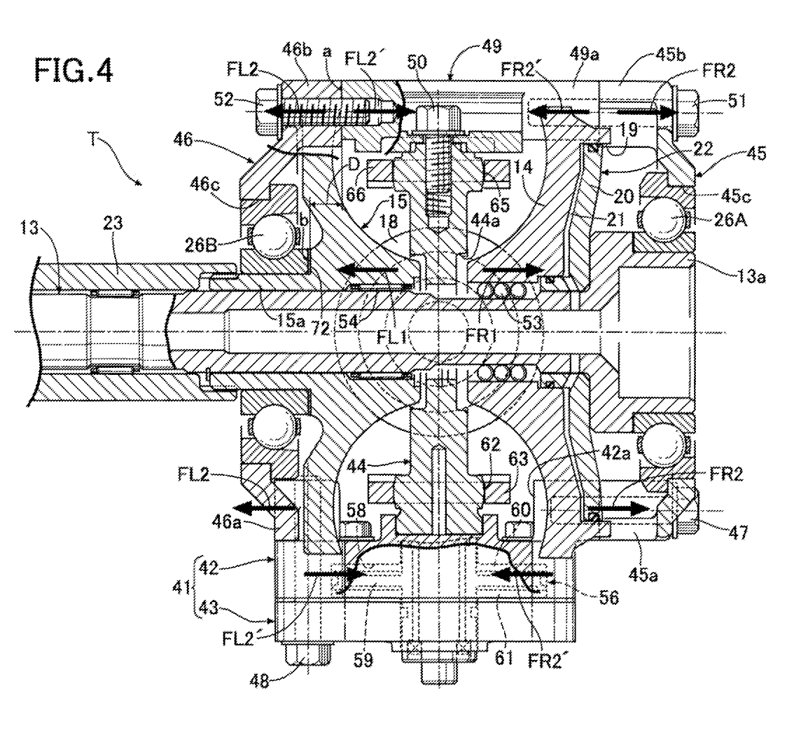

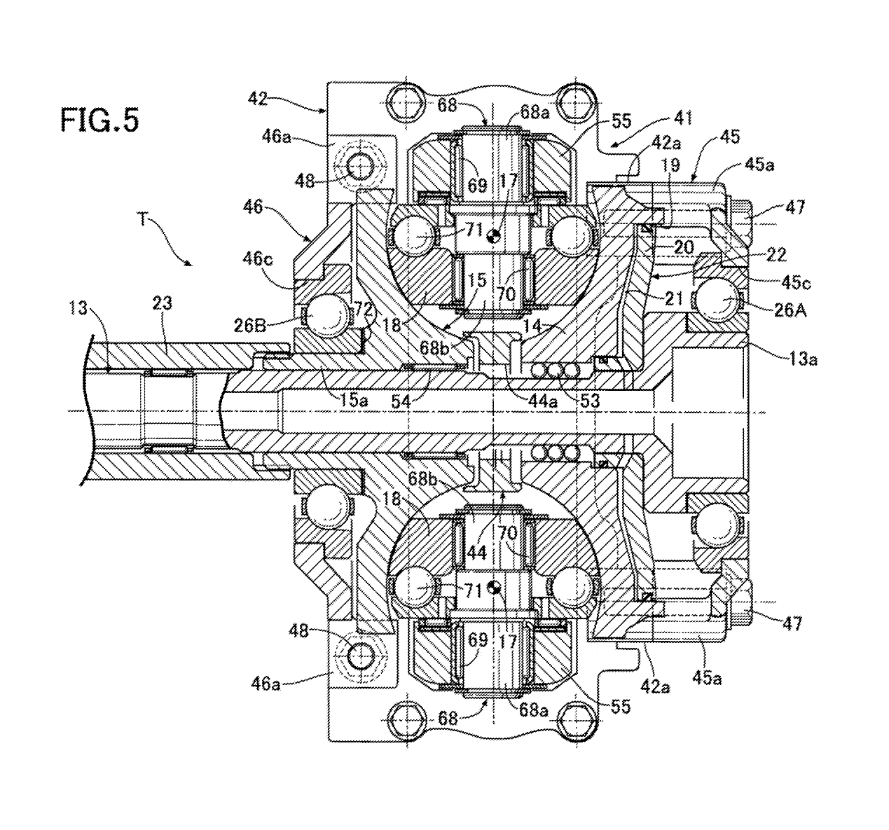

As clear from FIG. 4 and FIG. 5, when hydraulic pressure is supplied to the oil chamber 21 of the biasing means 22 in a way that the power rollers 18 do not slip over the input disc 14 or the output disc 15, the input disc 14 is biased leftward in FIG. 4 by the piston 20 fixed to the input shaft 13, and thus presses the power rollers 18 against the output disc 15. In other words, the output disc 15 is biased leftward in FIG. 4 with load FL1 by the reaction force which the output disc 15 receives from the power rollers 18; and the load FL1 is transmitted from the output disc 15 to the second support member 46 via the second thrust bearing 26B, and biases the second support member 46 leftward in FIG. 4 with load FL2. On the other hand, the input disc 14 is biased rightward in FIG. 4 with load FR1 by the reaction force which the input disc 14 receives from the power rollers 18; and the load FR1 is transmitted from the input disc 14 to the first support member 45 via the oil chamber 21, the piston 20, the large-diameter portion 13a of the input shaft 13, and the first thrust bearing 26A, as well as biases the first support member 45 rightward in FIG. 4 with load FR2.

Since, however, the first support member 45 and the second support member 46 are integrally connected together by means of the base member 41 and the connecting member 49, the leftward load FL2 and the rightward FR2 work only in a way that pulls the base member 41 and the connecting member 49 in the axial direction of the input shaft 13. Because the loads FL2, FR2 balance internal stresses FR2′, FL2′ of the base member 41 and the connecting member 49, no load in the axial direction is transmitted to the input shaft 13.

With regard to the input shaft 13, the reaction force FR1 with which the power rollers 18 bias the input disc 14 rightward biases the large-diameter portions 13a in the right end of the input shaft 13 rightward, while the reaction force FL1 with which the power rollers 18 bias the output disc 15 leftward does not bias the input shaft 13 leftward because the output disc 15 is capable of sliding over the input shaft 13 in the axial direction. Accordingly, no tensile load in the axial direction works on the input shaft 13.

As described above, the loads FR1, FL1 in the opposite directions to each other, which the input disc 14 and the output disc 15 receive from the power rollers 18, are eventually received by internal stresses FR2′, FL2′ of the base member 41 and the connecting member 49. For this reason, only torsional load due to the torque transmission works on the input shaft 13, and no tensile load in the axial direction works on the input shaft 13. This makes it possible to decrease the diameter of the input shaft 13, and accordingly to reduce the size and weight of the toroidal continuously variable transmission mechanism T.

Moreover, the bolts 51 connecting the first support member 45 and the connecting member 49, as well as the bolts 52 connecting the second support member 46 and the connecting member 49, are arranged in a direction in which the loads FL2, FR2 work. For this reason, even when the diameters of the bolts 51, 52 are decreased, not only can the loads FL2, FR2 be securely transmitted, but also the loosening of the bolts 51, 52 can be prevented.

Moreover, when the thickness of the shim 72 placed between the inner race of the second thrust bearing 26B and the stepped portion of the output disc 15 is to be determined, a distance D between an end surface a of the connecting member 49 and a stepped portion b of the output disc 15 shown in FIG. 4 needs to be measured. Since the bolts 52 fastening the second support member 46 are placed in the axial direction of the input shaft 13, the distance D can be easily measured by using the end surface a and the stepped portion b which are orthogonal to the axes of the bolts 52. This enhances the workability.

Although the foregoing descriptions have been provided, various design changes can be made within the scope, while not departing from the gist of the disclosure.

For example, the shapes of the first support member 45, the second support member 46 and the connecting member 49 are not limited to those shown in the embodiment.

We claim:

1. A toroidal continuously variable transmission mechanism, comprising:
an input disc supported by an input shaft in a way that is incapable of rotating relative to the input shaft and is slidable over the input shaft in an axial direction;
an output disc supported by the input shaft in a way that is capable of rotating relative to the input shaft and is slidable over the input shaft in the axial direction;
a pair of power rollers held between the input disc and the output disc;
a biasing device for biasing the input disc in a direction in which the input disc becomes closer to the output disc along the input shaft to press the input disc and the output disc against the pair of power rollers;
a base member;
a pair of trunnions for supporting the pair of power rollers in a way that is capable of tilting and turning, and supported by the base member in a way that is capable of sliding in a direction of trunnion axes;
a first bearing for supporting the input shaft on the input disc side;
a second bearing for supporting the output disc;
a first support member whose one end side is fixed to the base member, and which supports the first bearing;
a second support member whose one end side is fixed to the base member, and which supports the second bearing; and
a connecting member which connects opposite end sides of the first and second support members.

2. The toroidal continuously variable transmission mechanism of claim 1, wherein bolts for connecting the opposite end sides of the first and second support members to the connecting member are placed in a direction of an axis of the input shaft.

3. The toroidal continuously variable transmission mechanism of claim 2, wherein
a shim is held between the second bearing and the output shaft, and
an end surface of the connecting member with which the opposite end side of the second support member is in contact, and a side surface of the output disc with which the shim is in contact, are orthogonal to the axis of the input shaft.
